(19) United States
(12) Patent Application Publication
(10) Pub. No.: US 2011/0018468 A1
(43) Pub. Date: Jan. 27, 2011

(54) Illuminating Container

(76) Inventor: Lori A. Von Rueden, Redwood City, CA (US)

Correspondence Address: Nixon Peabody LLP, P.O. Box 60610, Palo Alto, CA, 94306, US

(21) Appl. No.: 12/815,367

(22) Filed: Jun. 14, 2010

Related U.S. Application Data
(60) Provisional application No. 61/228,931, filed on Jul. 27, 2009.

(51) Int. Cl. H05B 39/06

(52) U.S. Cl. 315/313

(57) ABSTRACT

A handheld container provides a chamber in which items to be carried may be stored as well as a down-projecting illuminator and optional illuminators projecting light in one or more other directions. An optional sound system is also provided.

### RELATED APPLICATIONS

This application claims the benefit of priority based on U.S. Provisional Patent Application Ser. No. 61/228,931, filed on Jul. 27, 2009, in the name of inventor Lori A. Von Rueden, entitled “Illuminating Container”, commonly owned herewith. The entirety of that provisional application is hereby incorporated herein by reference.

### TECHNICAL FIELD

The present disclosure relates generally to handheld containers.

### BACKGROUND

Handheld containers such as hand bags and the like are well-known in the art. They are generally used to carry small items.

### OVERVIEW

A handheld container provides a chamber in which items to be carried may be stored as well as a down-projecting illuminator and optional illuminators projecting light in one or more other directions. An optional sound system is also provided.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 is a left side elevational view of an illuminating container in accordance with an embodiment of the present invention.

FIG. 2 is a top plan view of an illuminating container in accordance with an embodiment of the present invention.

FIG. 3 is a front elevational view of an illuminating container in accordance with an embodiment of the present invention.

FIG. 4 is a right side elevational view of an illuminating container in accordance with an embodiment of the present invention.

FIG. 5 is a rear elevational view of an illuminating container in accordance with an embodiment of the present invention.

FIG. 6 is a bottom view of an illuminating container in accordance with an embodiment of the present invention.

FIG. 7 is a bottom view of an illuminating container in accordance with an embodiment of the present invention showing the bottom illuminator lit.

FIG. 8 is a bottom view of the unlit bottom illuminator of an illuminating container in accordance with an embodiment of the present invention.

FIG. 9 is a front right side perspective view of an illuminating container in accordance with an embodiment of the present invention showing the front illumination lit.

FIG. 10 is a front left side perspective view of an illuminating container in accordance with an embodiment of the present invention showing the bottom and front illuminators lit.

FIG. 11 is a front left side perspective view of an illuminating container in accordance with an embodiment of the present invention.

FIG. 12 is an electrical schematic diagram of a lighting circuit used for the illuminators in accordance with an embodiment of the present invention.

FIG. 13 is a block diagram of a reflector and lens assembly in accordance with an embodiment of the present invention.

FIG. 14 is an electrical schematic block diagram of a sound system in accordance with an embodiment of the present invention.

### DESCRIPTION OF EXAMPLE EMBODIMENTS

Example embodiments are described herein in the context of an illuminating container. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

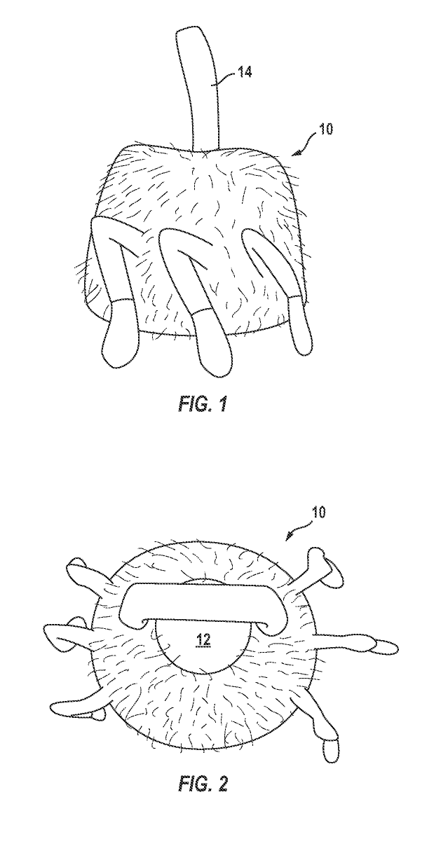

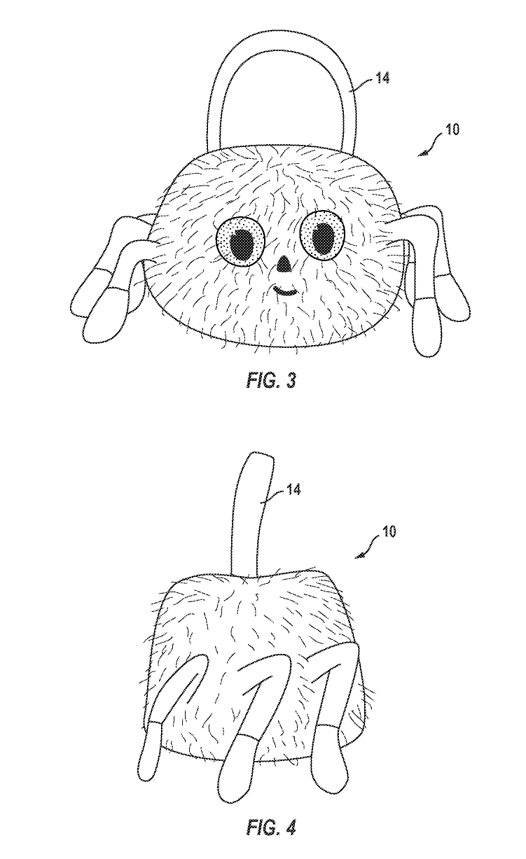

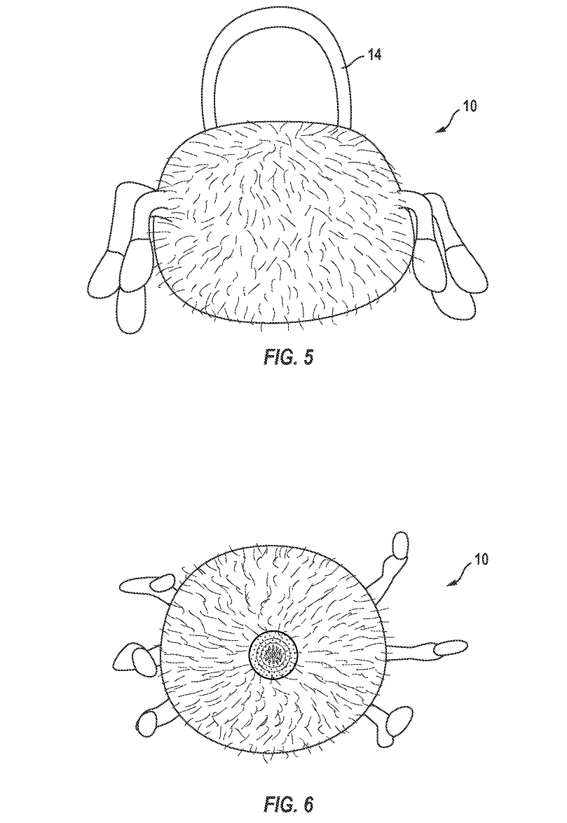

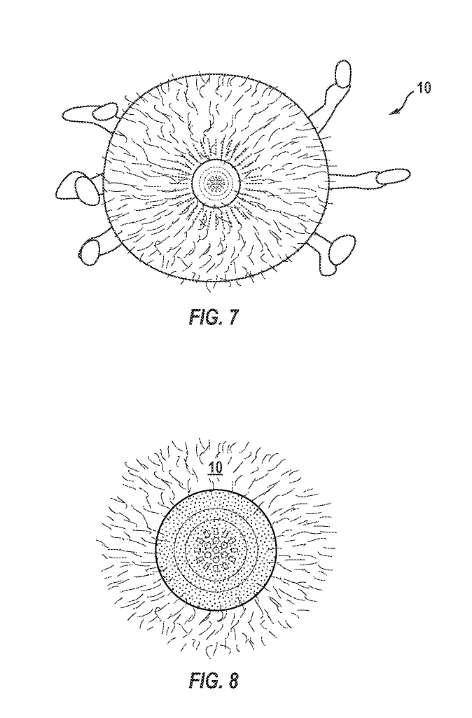

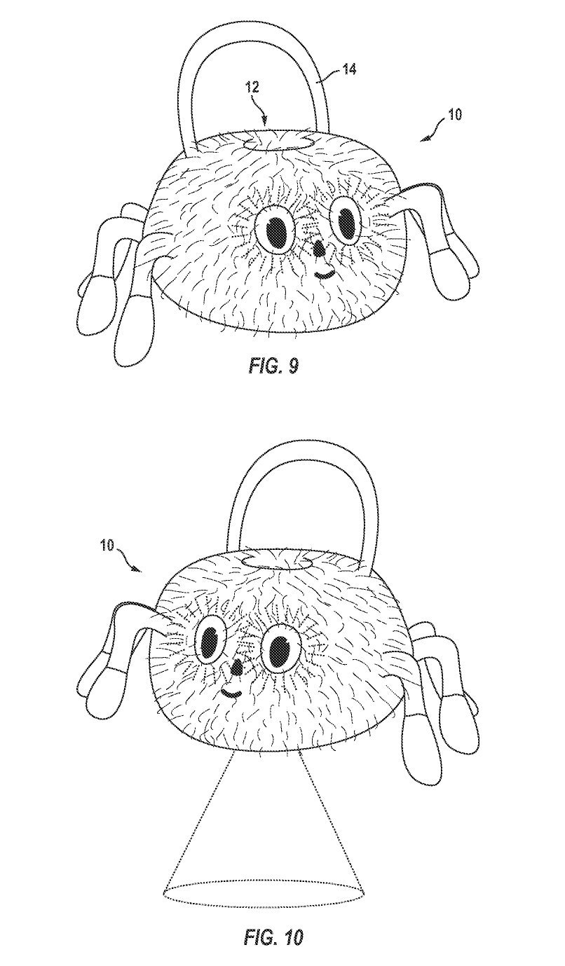

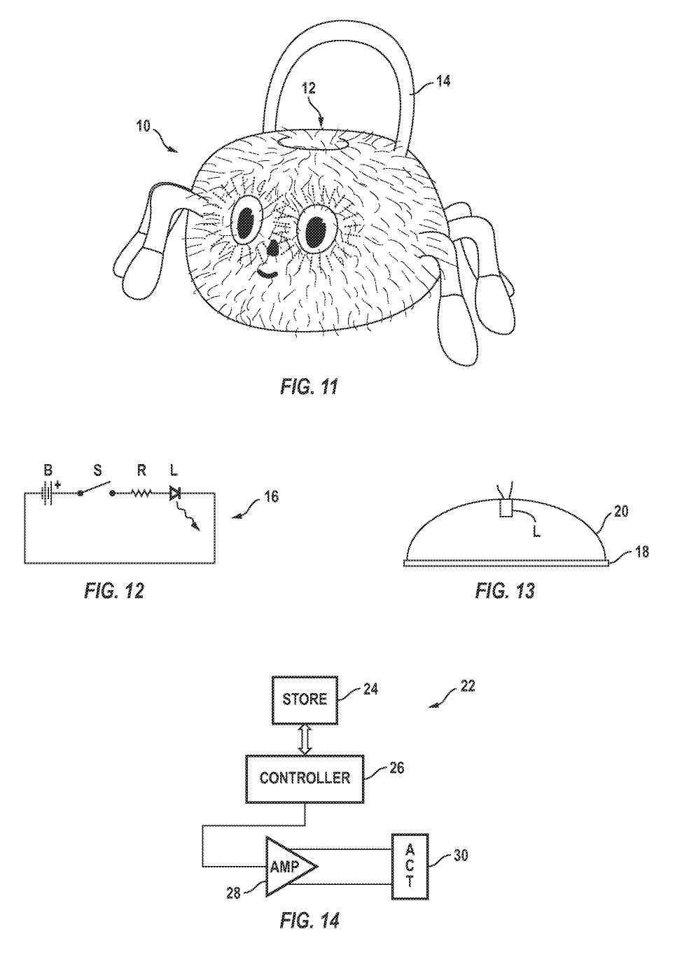

FIGS. 1-11 show various views as described above of a handheld illuminating container 10 in accordance with an embodiment of the present invention. The container 10 includes a top opening 12 for inserting items (not shown) to be carried in the container 10. The container 10 also includes a carrying handle 14 for hand carrying the container 10. A down-projecting illuminator 13 is provided in accordance with one embodiment. The down-projecting illuminator includes an illumination circuit 16 as shown, for example, in FIG. 12. The illumination circuit 16 of FIG. 12 includes a power source B such as a battery, a switch S (which may be of the SPST type and may be momentary or locking), a light source L (such as a light emitting diode or LED, or group of LEDs, or an incandescent, fluorescent or other type of light source) resistor R (used with LEDs) sized for the particular LEDs chosen for the circuit to limit current flow as known to those of ordinary skill in the art. The light source may project one or many colors of light including white light, as desired, and may be configured to project a continuous color of light or changing colors of light, as is known to those of ordinary skill in the art.

A lens 18 and/or reflector 20 as illustrated schematically in FIG. 13 may also be incorporated into illuminator 13 as is commonly employed with flashlights. The lens may be an optical component affecting the focus of light projected therethrough, or it may be a flat glass or plastic or other frosted, translucent or transparent component used to shield the components of the illuminator from dust and damage.

One or more switches S or other conventional controls may be incorporated into the handle 14, or otherwise located for convenience, and coupled to the illumination circuit 16 with conventional electric wires for controlling the operation of the illumination circuit 16.

The illuminator 13 is used for down projection of light as shown for example in FIG. 10. Optionally additional illuminators 13 may be used for forward (or other) projection of light. In the example shown the container 10 is fashioned to look like a creature having a down-projecting light as well as a pair of eyes facing forward which also house illuminators for projecting light. Other configurations will now be apparent to those of ordinary skill in the art having the benefit of this disclosure. For example, such other projections of light could include projected images or cut-out images of objects or be for the purpose of providing a decorative or entertaining effect.

The illuminators may be set or controlled to provide steady output, changing output intensity, blinking or flashing output, or other types of light output, as desired. They may be controlled together or separately with one or more switches or other conventional controls. Such switches or controls may be mounted to the handle 14 or body of the container 10. Microprocessor control may be used to add complex flashing sequences via a conventional driver circuit to the illuminators 13 as is known in the art. Different illuminators used in the container may have different properties, e.g., the down-projecting illuminator may have higher intensity than forward projecting illuminators, and the like.

A sound system 22 (FIG. 14) may also be incorporated into the container 10 to emit an audible signal such as an audibly perceptible sound track, to accompany the light projected thereby. Such sound system may be implemented, for example, by a memory storing a digital sound track 24, a controller 26, an audio amplifier 28 and a speaker 30 or other type of actuator for generating the audible sounds. Other implementations will now be apparent to those of ordinary skill in the art.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. An illuminating container comprising:
a chamber for containing items to be carried in the container;
a handle;
at least one first illuminator configured to project light in a downward direction;
a switch controlling the at least one first illuminator.

2. The illuminating container of claim 1, further comprising:
at least one second illuminator configured to project light in a direction different from the direction light is projected from the at least one first illuminator.

3. The illuminating container of claim 2, further comprising:
a sound system configured to emit an audible signal.

4. An illuminating container, comprising:
a body;
a chamber within the body configured to hold items;
an opening in the body through which items may be placed into and removed from the chamber;
a handle coupled to the body;
at least one first illuminator mounted to the body and configured to project light downward from the body as it is carried by the handle;
at least one second illuminator mounted to the body and configured to project light in a direction different from the direction light is projected from the at least one first illuminator; and
at least one control configured to control operation of the at least one first illuminator and at least one second illuminator.

5. The illuminating container of claim 4, wherein the at least one control is mounted to the body.

6. The illuminating container of claim 4, wherein the at least one control is mounted to the handle.

7. The illuminating container of claim 6, wherein the at lest one first illuminator and at least one second illuminator are configured to be powered by a battery mounted within the body.

8. The illuminating container of claim 7, further comprising:
a sound system configured to project sound, the sound system mounted within the body.
